(19) United States
(12) Patent Application Publication
(10) Pub. No.: US 2008/0027773 A1
(43) Pub. Date: Jan. 31, 2008

(54) System and method for self-assessed commitment management

(75) Inventor: Ip-Ming Stephen Law, Piscataway, NJ (US)

Correspondence Address: MORGAN LEWIS & BOCKIUS LLP, 1111 PENNSYLVANIA AVENUE NW, WASHINGTON, DC, 20004, US

(73) Assignee: Wisage Technology, Inc.

(21) Appl. No.: 11/826,386

(22) Filed: Jul. 13, 2007

Related U.S. Application Data
(60) Provisional application No. 60/830,669, filed on Jul. 14, 2006.

(51) Int. Cl. G06F 9/44

(52) U.S. Cl. 705/7

(57) ABSTRACT

A system and method that allow an individual or a party to capture, organize, assess, understand, and agree to one or more pre-defined conditions. The agreement is made to a person or a party as an obligation of the individual(s) who is/are offering the agreement. Once the obligation is offered and is accepted, it will be continuously monitored and evaluated until the commitment is either fulfilled, renegotiated, or broken.

### CROSS REFERENCE TO RELATED APPLICATIONS

This application claims the benefit of U.S. Provisional Application No. 60/830,669, filed on Jul. 14, 2006, which is hereby incorporated by reference in its entirety.

### NOTICE OF COPYRIGHTED MATERIAL IN DISCLOSURE

A portion of the disclosure of this patent application document contains material that is subject to copyright protection. The copyright owner has no objection to the facsimile reproduction by anyone of the patent application document or of the patent disclosure, as it appears in the Patent and Trademark Office patent file or records, but otherwise reserves all copyright rights whatsoever.

### BACKGROUND OF THE INVENTION

### 1. Field of the Invention

The present invention relates generally to a system and method for commitment management and, more particularly, to a system and method for allowing an individual or a party to capture, organize, assess, understand, and agree to one or more pre-defined conditions. The agreement is made to a person or a party as an obligation of the individual(s) who is/are offering the agreement. Once the obligation is offered and is accepted, it will be continuously monitored and evaluated until the commitment is either fulfilled or broken.

### SUMMARY OF THE INVENTION

A system and method in accordance with the present invention manage one or more conditions that must be satisfied to successfully fulfill a commitment. In accordance with the system and method, a commitment is comprised of one or more conditions. These conditions represent the criteria by which they would be evaluated to determine if the commitment has been successfully fulfilled or not. These conditions are made up by a combination of one or more activity and/or deliverable and their corresponding schedules, resource requirements, and estimated costs of a project plan.

A person or persons may create one or more conditions and include them in a commitment. When the person or persons (delivering-party) decide to commit themselves to deliver according to the conditions specified in a commitment, they submit the commitment for acceptance. The person or persons (receiving-party) who the commitment is submitted to for acceptance may accept or reject depending on their satisfaction to the conditions specified in the commitment. In the event of a rejection, renegotiation and enhancement and/or addition to the underlying conditions are expected for subsequent resubmission.

A commitment, once accepted, is non-negotiable. It works as a contract between the delivering-party and the receiving-party. The contract terms are the conditions specified for delivery and their corresponding fulfillment criteria. These conditions are not allowed to be changed once the commitment is accepted by the receiving-party.

All commitments are subject to periodic tracking and evaluation to determine if fulfillment has been satisfactorily achieved. A daily tracking and evaluation will be a minimum. Event-driven tracking and evaluation is provided for real-time performance; e.g. when the delivering-party presses the “deliver” button. When the commitment is due by the schedule committed by the delivering-party and accepted by the receiving-party, failure of any condition specified will constitute the commitment as broken commitment. Only when all the conditions specified are successfully delivered by the defined criteria can a commitment be considered successfully fulfilled.

Prior to a commitment, the delivering-party must assess its own ability to deliver the conditions specified. Good organization of the information regarding their underlying activities, deliverable, resources requirements, estimated costs, schedules and their dependencies is useful for an all-embracing assessment. Negotiation may take place before commitment revising the conditions to be included in a commitment between delivering-party and receiving-party. When positive assessment is reached by the delivering-party as to its own ability to deliver by the conditions specified, a commitment is then proposed to the receiving-party for acceptance. The receiving-party may accept or reject the proposed commitment depending on its satisfaction to the conditions specified.

Prior to the due date specified for a commitment, renegotiation of the conditions specified is possible but not directly changeable. The receiving-party may relinquish an earlier accepted commitment upon request by the delivering-party. On the other hand, the delivering-party may force break a commitment without agreement by the receiving-party. In the event of relinquishment granted by the receiving-party, it will not be counted as broken commitment towards the track record of the delivering-party. Force break a commitment will be treated as a broken commitment.

### BRIEF DESCRIPTIONS OF DRAWINGS

FIG. 1 is a typical configuration showing three basic elements of the invention.

FIGS. 2-14 depict exemplary logical screen shots that take place between creation and acceptance of a commitment in accordance with an exemplary embodiment of the present invention.

FIG. 15 is a process flow diagram of a commitment from creation to completion.

FIGS. 16-21 provide an example of the processes involved from creation to acceptance of a commitment in accordance with an exemplary embodiment of the present invention.

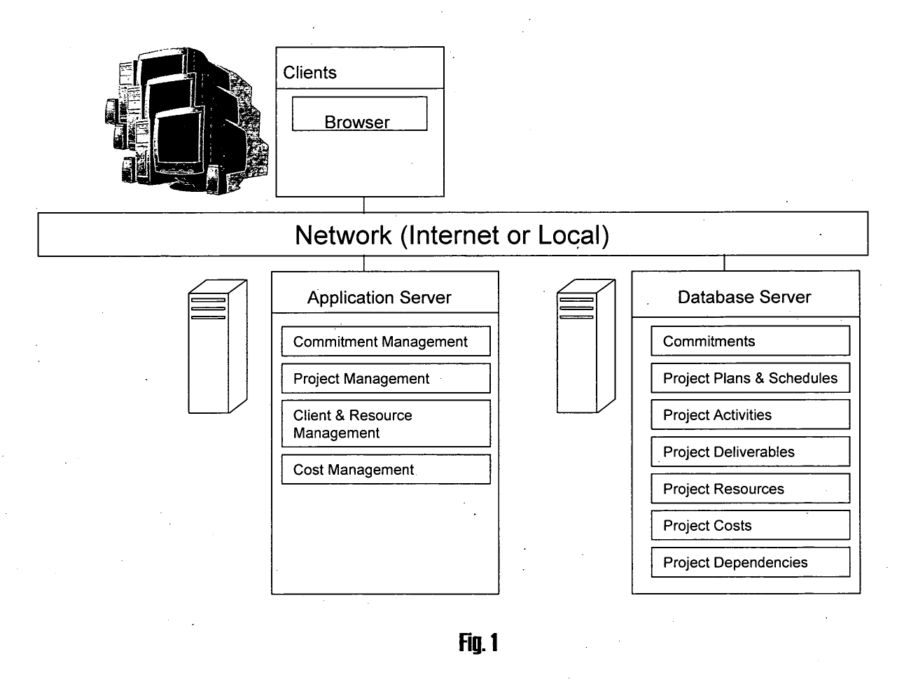

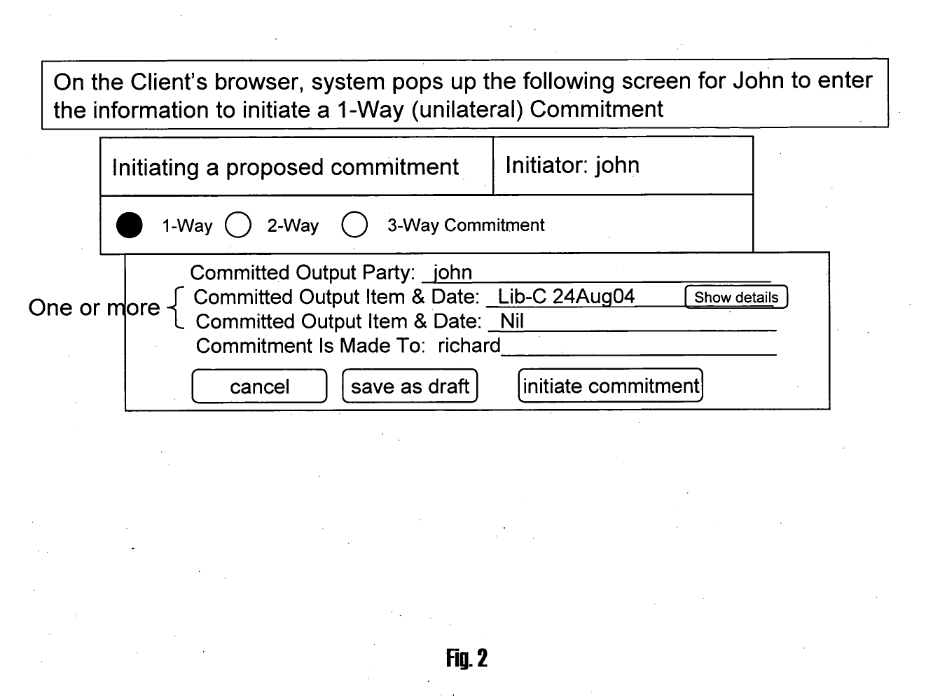

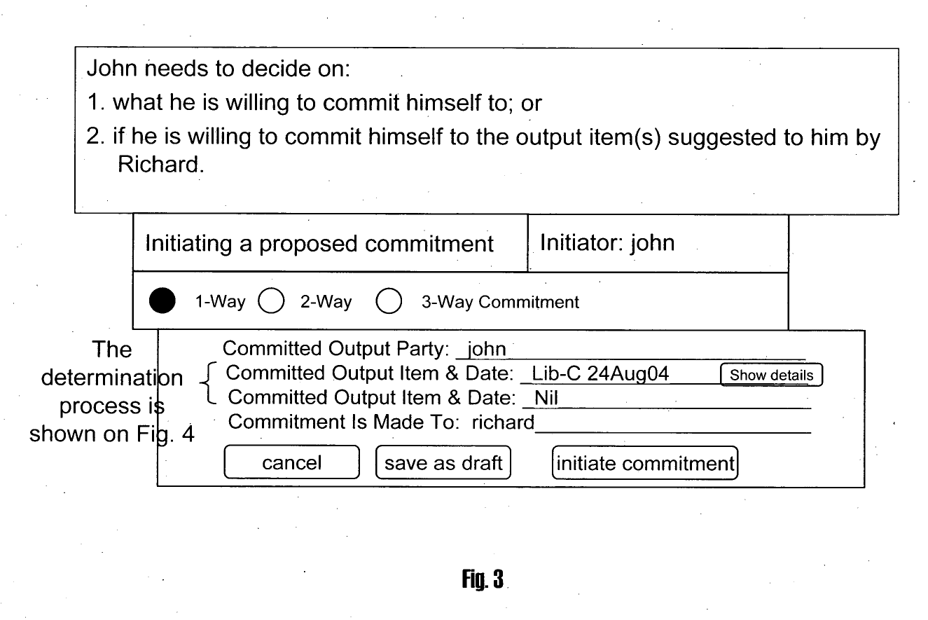

### DESCRIPTION OF THE PREFERRED EMBODIMENTS

It has generally been difficult to express a commitment in a structured manner so that subsequent tracking of its fulfillment is possible. The person or persons offering a commitment usually provide only an end result to which the persons are committed. It is rather seldom for the persons offering a commitment would also provide the criteria by which the end result would be evaluated to determine if fulfillment has been achieved or not. Furthermore, expression of the end result and the criteria in a structured manner so that automated tracking and evaluation of their fulfillments is a rather difficult task and errors can easily occur.

A need therefore exists for a system and method which can capture the target end result and the fulfillment criteria in a structured manner so that automated tracking and evaluation of its achievements against fulfillment criteria are possible.

A system and method in accordance with the present invention allows a commitment requiring the fulfillment of one or more conditions to be efficiently managed and tracked. In accordance with one embodiment of the invention, a person or persons (the delivering-party) create a commitment by specifying one or more conditions. These conditions collectively stipulate one or more target achievements and their corresponding completion criteria.

These conditions are components of a project plan. The project plan is made up by one or more activities. One or more deliverables are to be produced by the project and/or by selected activities. Deliverables may be goods and/or services. Their schedules, estimated costs, and resources are specified as their completion criteria. When the delivering-party is ready to stipulate the details of its undertaking, the project plan and its components are to be appraised, modified, and selected.

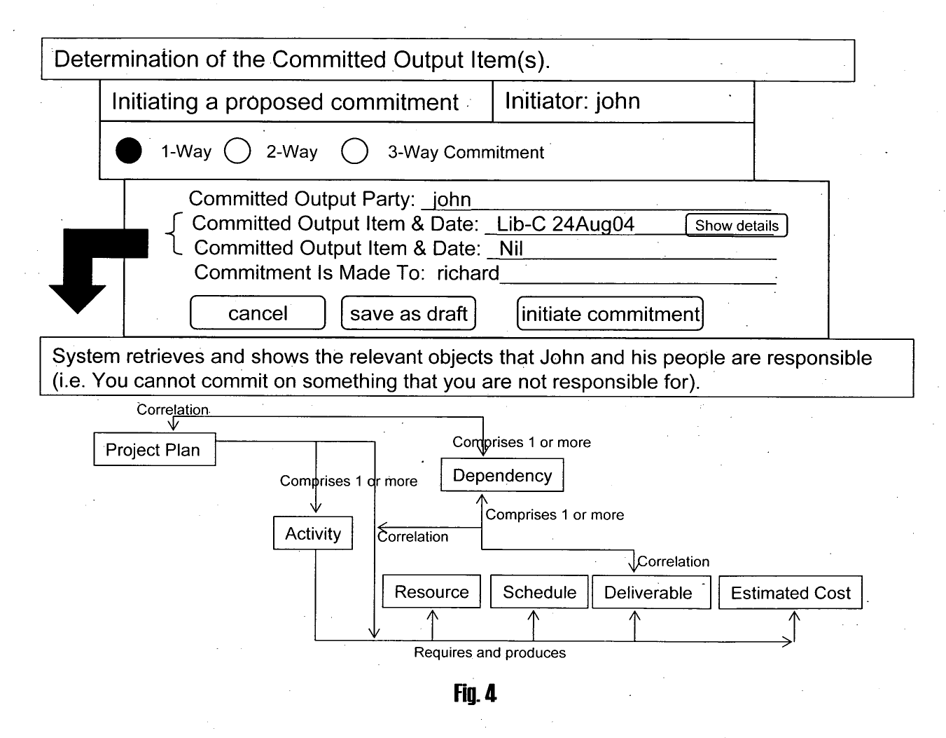

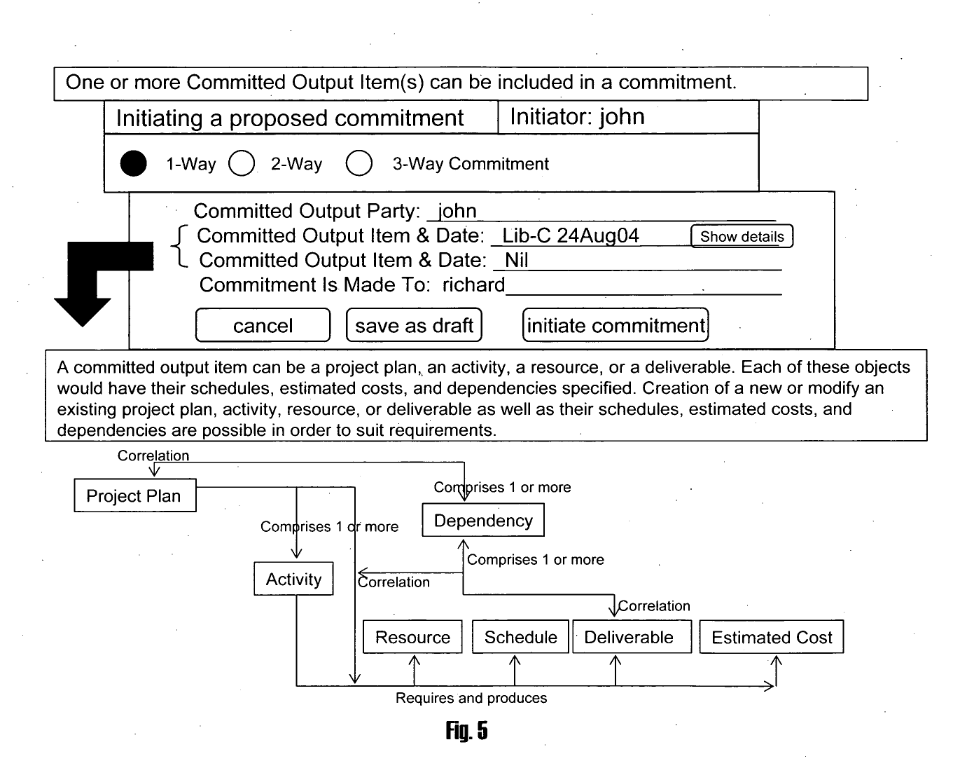

In one exemplary embodiment, illustrated in FIG. 4, a project plan is a tree structure whereby it comprises one or more sub-project plan, activity, resource, deliverable, schedule, estimated cost, and the dependencies among these objects stipulating their correlations and sequences. In this embodiments and others, the delivering-party is able to access and display the relevant parts of the tree structure that they are authorized for a complete assessment and understanding.

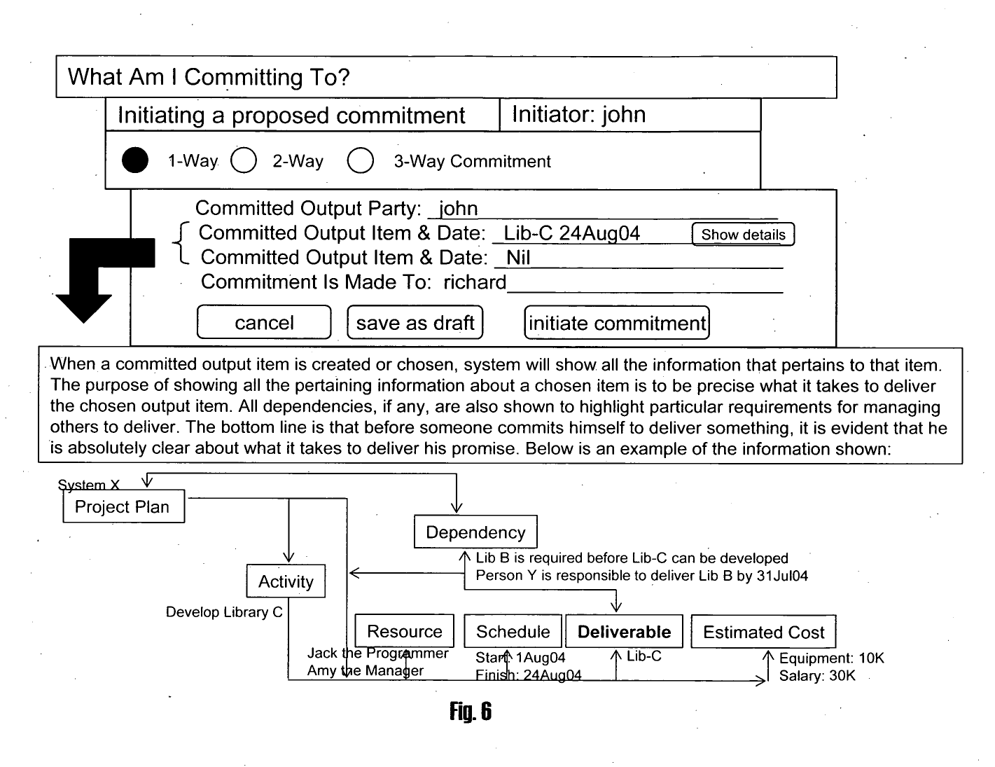

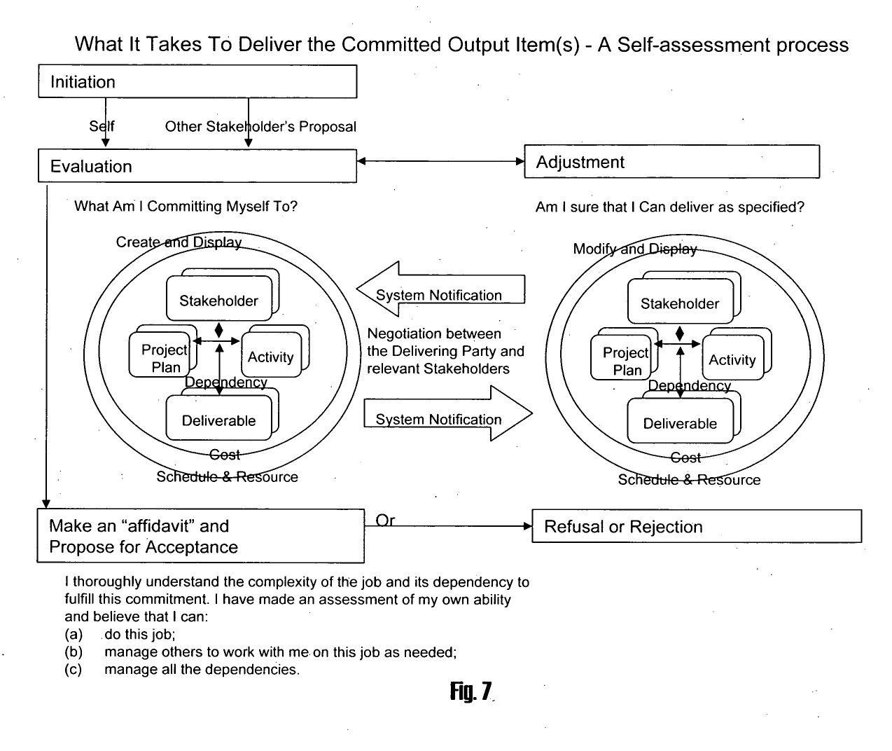

Prior to an undertaking of a commitment, the delivering-party may define the project plan and/or its components including sub-project plans, activities, resources requirement, schedules, estimated cost, and their dependencies. Both the delivering party and the intended receiving-party may display the project plan and all its components for their assessment. Assessment can be all-embracing since every detail of every aspect of the project is clearly detailed and visible. The delivering-party will then select some or all of these components to become conditions for a commitment. These conditions become the target achievements and their completion criteria for a commitment. Self-assessment and understanding of all the target achievements and their completion criteria are elements for the delivery-party. Ability to fulfill a commitment as specified is a self-assessment and understanding process. FIG. 6 explains this process that is considered necessary for any responsible commitment. Evaluation of the scope and depth of the potential commitment is needed for an initial understanding. Changes to the criteria and their requirements might be needed in relation to the delivering party's judgment of its ability and circumstances. Negotiation between the delivering party and relevant stakeholders is expected in order to arrive at a mutually satisfactory ground for possible agreement on the criteria and requirements that would form the ultimate commitment. Finally, decision can be reached by the delivering party whether a commitment can be proposed given the specified conditions and criteria or no commitment can be made. All the data flow, negotiation, and decisions are kept and facilitated by the system.

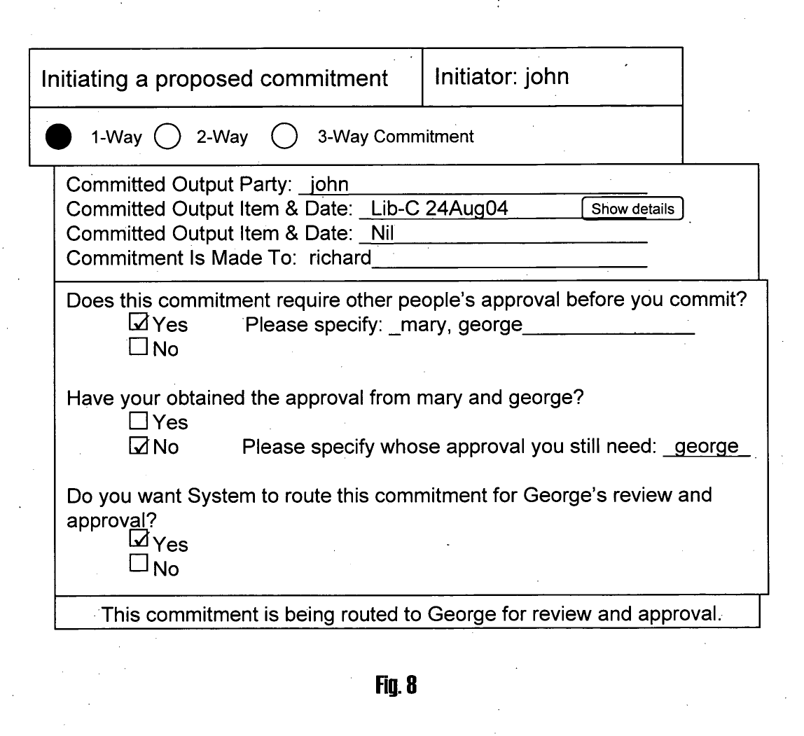

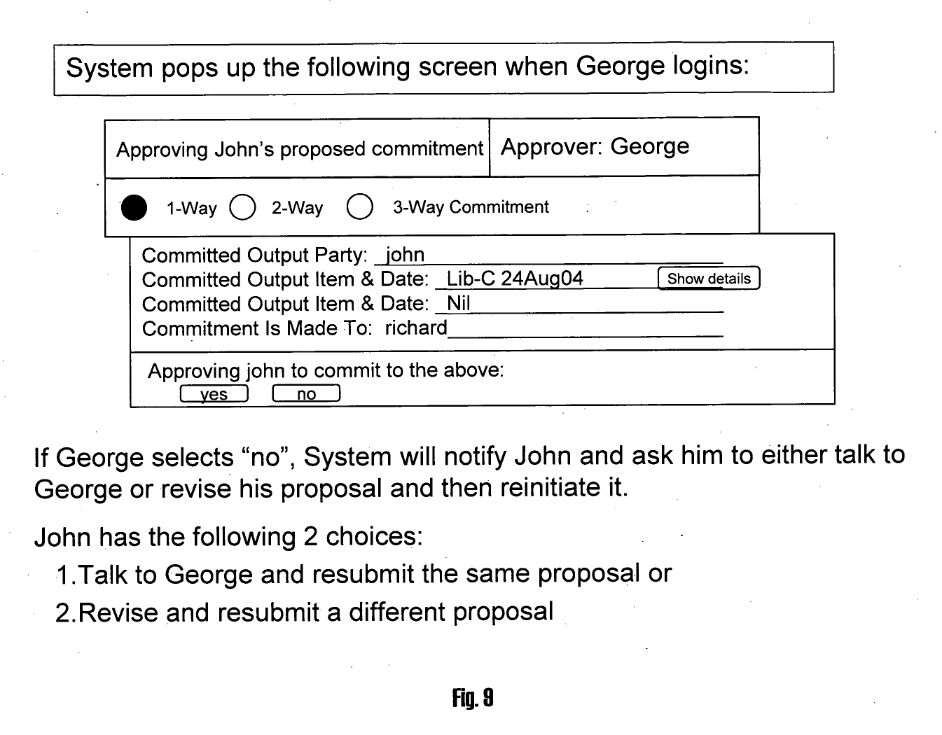

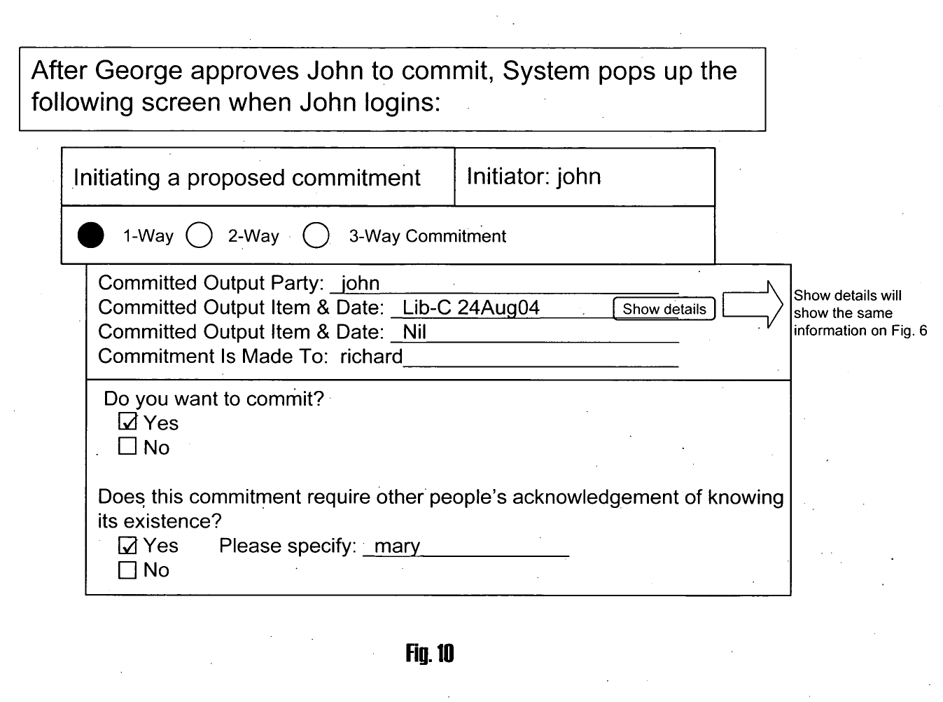

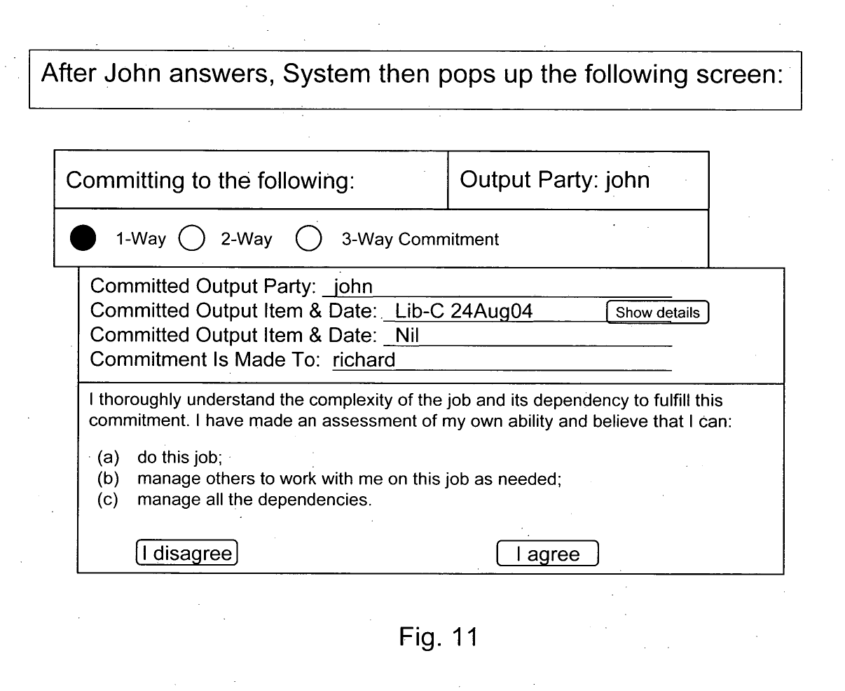

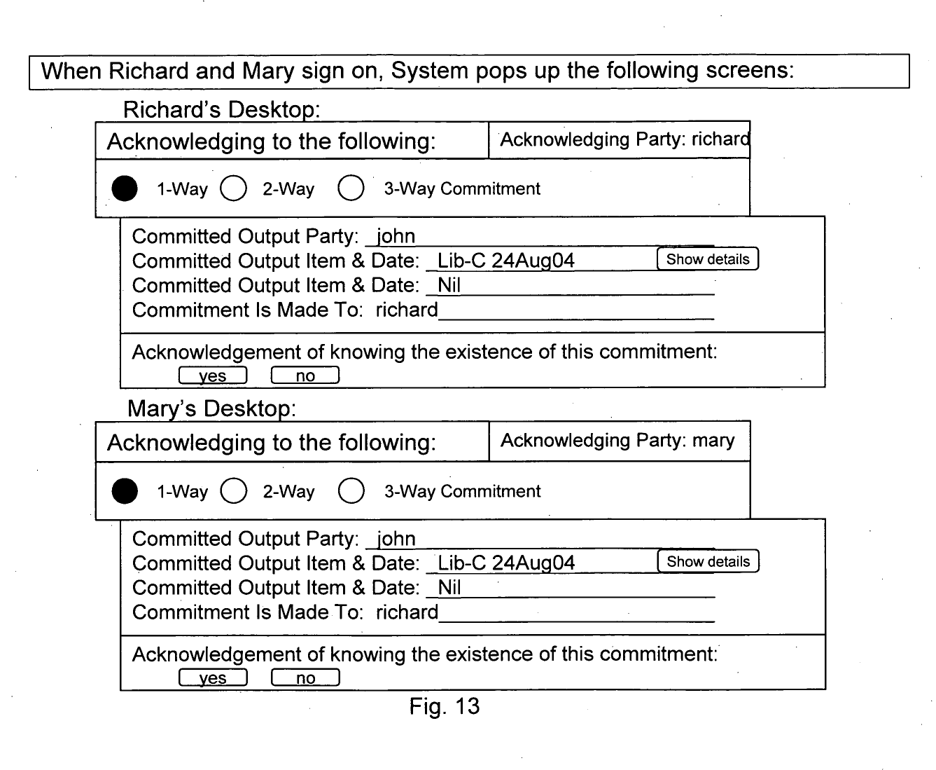

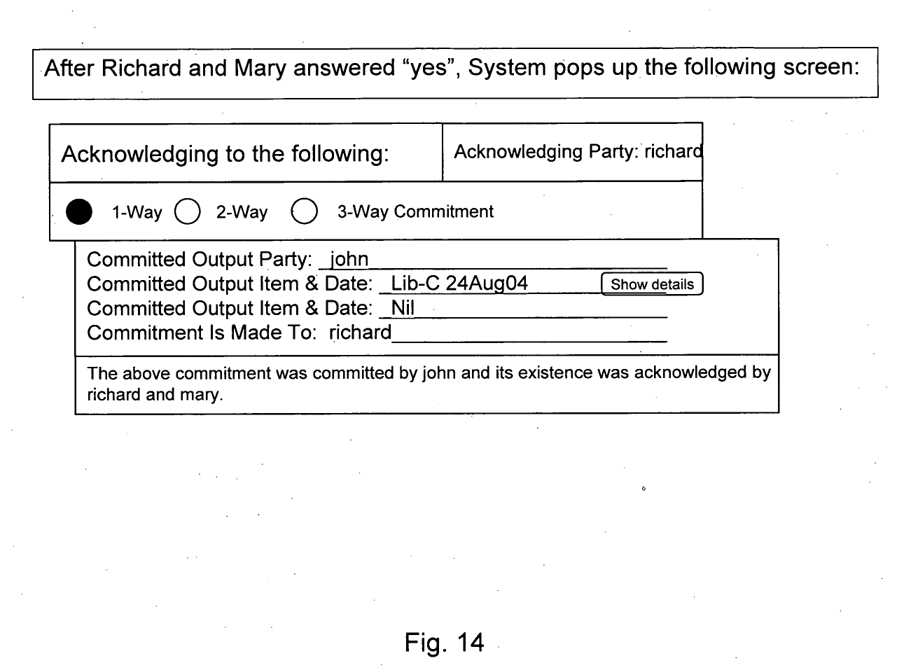

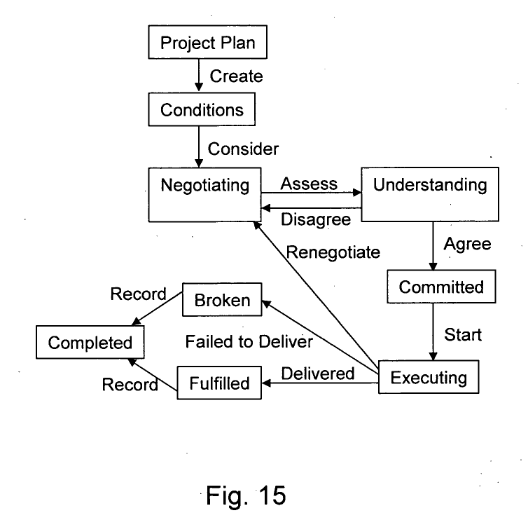

When the delivering-party is ready to commit given positive result from the self-assessment and understanding process, a commitment is then proposed to the receiving-party for acceptance. FIGS. 8, 9, 10, 11, 12, 13, and 14 are logical screen shots illustrated for a commitment proposal. Once accepted by the receiving-party, the delivering-party is held responsible to deliver all the target achievements by their corresponding completion criteria as specified as conditions in a commitment.

In accordance with another exemplary embodiment, the commitment needs to be approved by a third party for purpose of authenticity verification before proposal to the receiving-party is made. FIGS. 8, 9, and 10 depict the approval process by a third party. In FIG. 8, when John is ready to commit (by clicking the initiation button), System will ensure that John obtains all the proper approval before making a commitment.

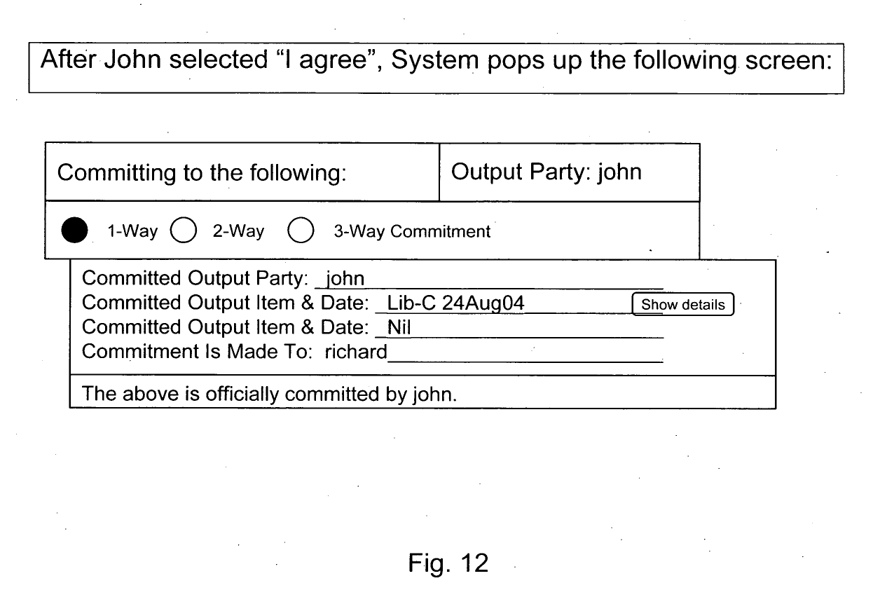

In accordance with another exemplary embodiment of the present invention, third party acknowledgement to the existence of a commitment is also supported for purpose of witnessing. FIGS. 12, 13, and 14 are logical screen shots for the witnessing process.

Prior to the due date specified for a commitment, renegotiation of the conditions is not possible except through a relinquishment by the receiving-party. If the receiving-party relinquishes an earlier made commitment, the delivering-party will no longer be held responsible. On the other hand, the delivering-party may only force-break a commitment if delivery is foreseen not possible by the conditions specified and the receiving-party is not willing to relinquish an earlier made commitment for revised conditions to be specified. Force-breaking a commitment is identical to a broken commitment for failed delivery by the agreed conditions.

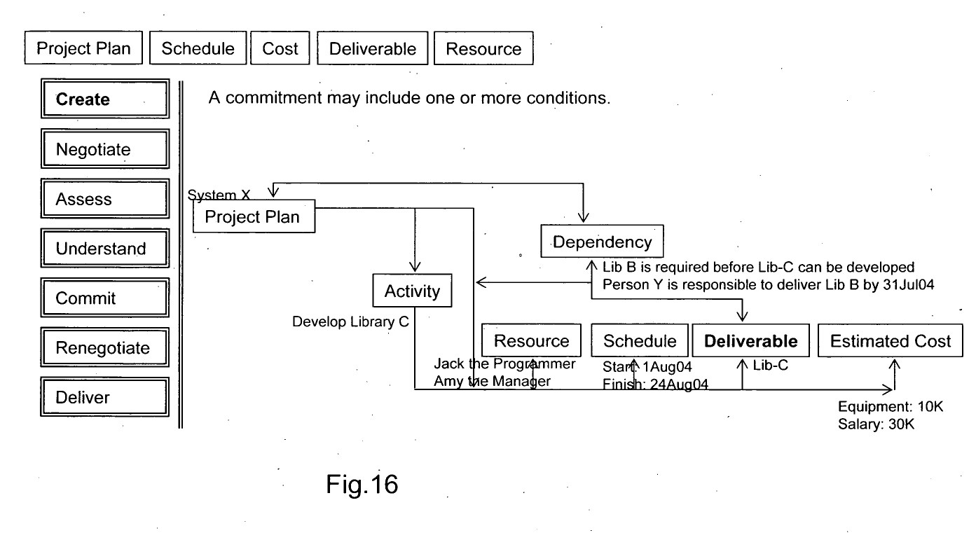

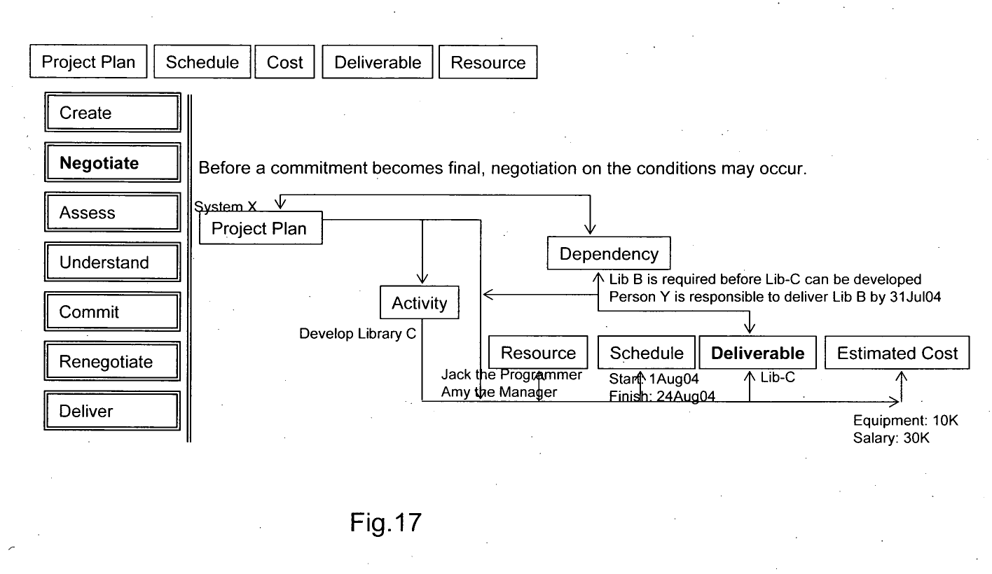

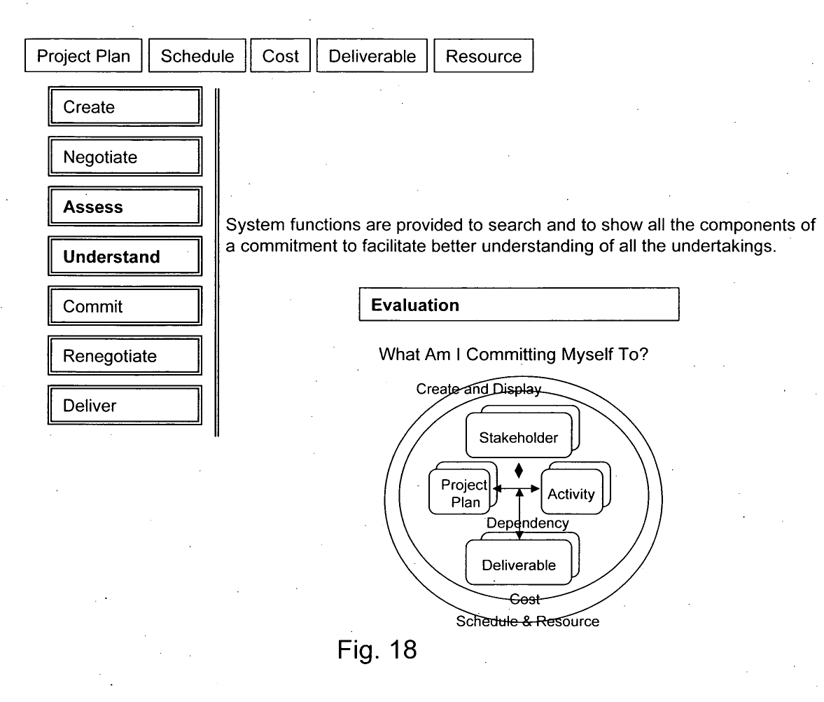

FIGS. 16-21 provide an example of the processes involved from creation to acceptance of a commitment in accordance with an exemplary embodiment of the present invention. In FIG. 16, a commitment may include one or more conditions. Each of these conditions is represented by one or more components of a project plan. These components are shown in FIG. 16 and the fine prints are examples for illustration purpose. In FIG. 17, before a commitment becomes final, negotiation on the conditions may occur. System functions are provided to facilitate changes to any conditions to be made by any persons who are responsible for the delivery of these conditions. In FIG. 18, System functions are provided to search and to show all the components of a commitment to facilitate better understanding of all the undertakings.

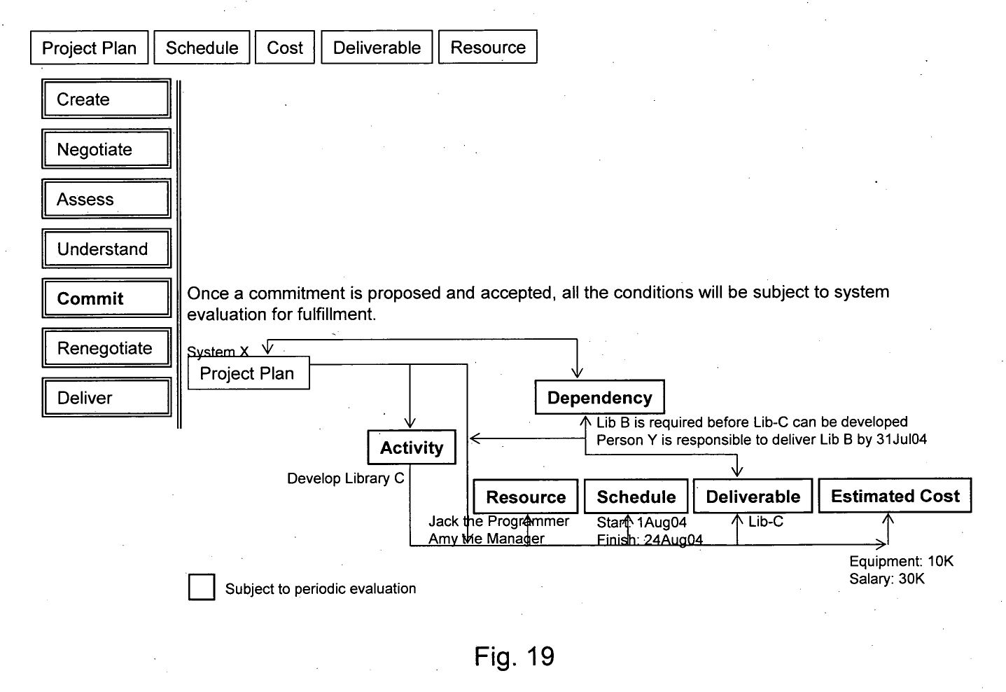

In FIG. 19, once a commitment is proposed and accepted, all the conditions will be subject to system evaluation for fulfillment. Reminders are sent to relevant parties at pre-determined times on or before their due dates. When due dates are reached and their fulfillments have not yet been satisfied, the commitment would be considered broken. Broken commitments are made known through displays and messages to everyone relevant including delivery- and receiving-parties' bosses in accordance with the organizational hierarchy specified.

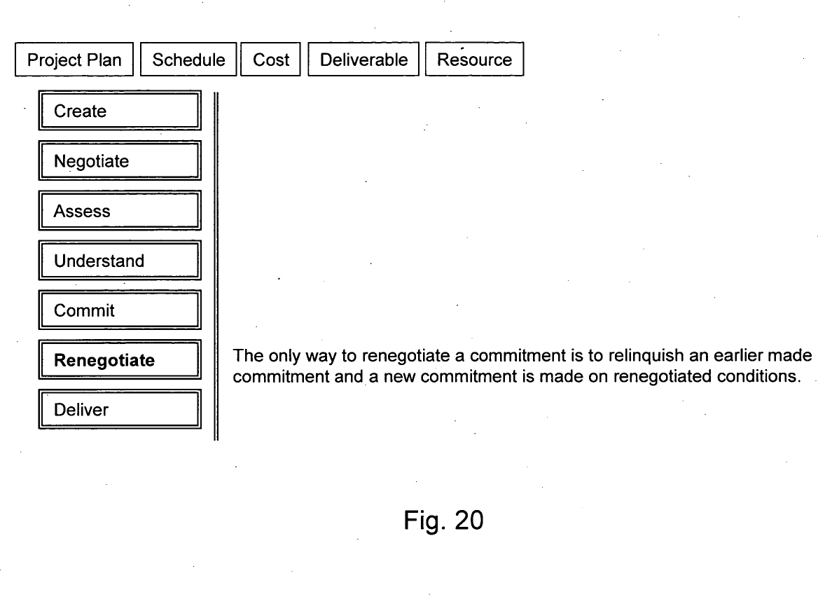

In FIG. 20, a commitment is non-negotiable once made except that the person or persons who accepted the commitment is/are willing to relinquish the commitment made earlier to them. Subsequent changing any of the conditions committed is not allowed since it can be never ending and, most importantly, it defeats the purpose of a commitment. The only way to renegotiate a commitment is to relinquish an earlier made commitment and a new commitment is made on renegotiated conditions. System functions are provided to relinquish a commitment. Relinquishing a commitment requires the person's or persons' agreement who accepted the commitment previously. A message is sent by the system asking for the agreement from the receiving-party. Accepted commitment relinquishment will not be counted as broken commitment towards the person or person(s) who committed to deliver. On the other hand, if commitment relinquishment is considered not acceptable, force break a commitment by the person or persons who committed to deliver will be the only way out from a commitment arrangement.

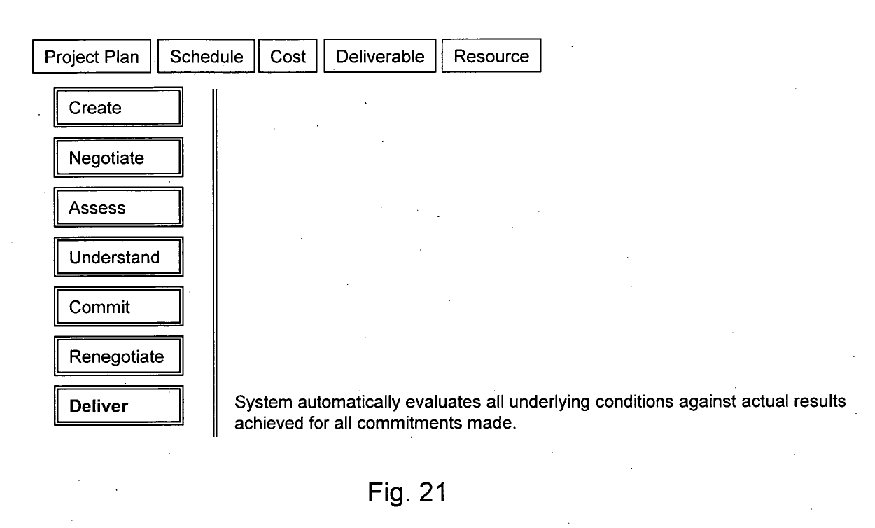

In FIG. 21, System automatically evaluates all underlying conditions against actual results achieved for all commitments made. Any gap in the achievement constitutes failed delivery as broken commitment. Conversely, the commitment is considered fulfilled if the achievement meets or exceeds committed conditions. Both fulfilled and broken commitments are made known through displays and messages to everyone relevant including delivery- and receiving-parties' bosses in accordance with the organizational hierarchy specified.

It will be readily apparent to one skilled in the art that other various modifications may be made to the embodiments without departing from the spirit and scope of the invention as defined by the appended claims.

What is claimed is:

1. A method for capturing, organizing, assessing, understanding and agreeing to one or more condition, comprising the steps of:
a. defining at least one condition for subsequent agreement or disagreement;
b. capturing the defined condition(s) and forming a basis of agreement between two or more individuals or parties;
c. assessing and understanding the dependency(ies) and criteria for their fulfillment given the defined condition(s);
d. agreeing or disagreeing to the defined condition(s); and
e. keeping a history of the agreements made and their fulfillments by the individual or party who made them, the conditions that had been agreed upon, and their fulfillment criteria.

2. The method as set forth in claim 1, further comprising the steps of:
a. facilitating a self-assessment process by allowing an individual or party to initiate or to propose someone else for an evaluation sub-process. The evaluation is to determine the scope and depth of a potential commitment object;
b. evaluating the scope and depth of a potential commitment object in relation to the evaluators' own ability to deliver as specified;
c. determining if changes are desired to the scope and depth of a potential commitment by negotiating with relevant stakeholders to arrive at a mutually agreeable ground for an able delivery;
d. deciding on the conditions and criteria by which delivery will be judged in the event a commitment is made; and
e. proposing a commitment that contains the agreeable conditions and criteria for acceptance.

3. The method as set forth in claim 2, further comprising the steps of:
a. creating at least one activity, deliverable, resource demand, budget demand, or acquisition demand for producing a commitment object;
b. capturing a commitment object and defining the requisite condition(s) that is/are considered the criteria for fulfillment; and
c. generating a commitment containing the commitment object and the criteria for its fulfillment.

4. The method as set forth in claim 3, further comprising the steps of:
a. proposing the said commitment to at least one recipient for acceptance or rejection;
b. in the event of acceptance, the said commitment will be recorded for subsequent tracking purposes between the committer and the party who accepts such commitment; and
c. in the event of rejection, the said commitment will be considered terminated and no further tracking will be done.

5. The method as set forth in claim 4, further comprising the steps of:
a. testing error and status messages;
b. revising at least one of said activity, said deliverable, said resource demand, said budget demand, said acquisition demand, said fulfillment criteria, or said commitment upon one of said error or status messages; and
c. repeating said proposing, accepting, rejecting, testing, and revising steps until none of said error or status messages is received.

6. A system comprising a transaction object for processing said data received by a relational database.
